(19) United States
(12) Patent Application Publication
(10) Pub. No.: US 2023/0403763 A1
(43) Pub. Date: Dec. 14, 2023

(54) FLEXIBLE HEAT GENERATOR AND A MANUFACTURING METHOD THEREOF

(71) Applicant: Henkel AG & Co. KGaA, Dusseldorf (DE)

(72) Inventors: Jing Yang, Shanghai (CN); WeiFeng Tan, Shanghai (CN); Xun Mo, Shanghai (CN)

(21) Appl. No.: 18/457,631

(22) Filed: Aug. 29, 2023

Related U.S. Application Data
(63) Continuation of application No. PCT/CN21/79044, filed on Mar. 4, 2021.

(51) Int. Cl. H05B 3/36; H05B 3/12; H05B 3/14

(52) U.S. Cl. CPC H05B 3/36; H05B 3/12; H05B 3/145; H05B 2203/017; H05B 2203/013; H05B 2203/02; H05B 2203/006

(57) ABSTRACT

The present disclosure discloses a flexible heat generator (1), comprising: a first flexible substrate layer (11), a first conductive line (12) comprising a first positive line (121) and a first negative line (122), a first heat generating line (13), a second flexible substrate layer (14), and a first connector (15), wherein the first positive line (121) and the first negative line (122) are not directly connected to each other, and wherein the first positive line (121) is electrically connected to the first negative line (122) by means of the first heat generating line (13). The present disclosure further discloses a method of manufacturing such flexible heat generator (1).

### TECHNICAL FIELD

The present application relates to a flexible heat generator, and to a manufacturing method thereof.

### BACKGROUND

Flexible heat generators are bendable heat generating devices that are suitable for use in complex or variable shaped devices to provide warmth. The common applications of flexible heat generators are for example steering wheels of motor vehicles, fabrics, medical devices, etc. However, the flexible heat generators in the prior art have various drawbacks. For example, the heating patch uses the principle of converting chemical energy into heat energy by adding a cloth patch coated with chemical materials into the fabric to generate heat. Its heating time is long and the cost is low, but the temperature is not controllable, easy to overheat, and only supports one-time use, and discarding it after use will cause pollution to the environment, and it generally contains chemical catalysts that are harmful to humans. The prior art also provides a solution of implanting the carbon fiber heat emitter connected to the power source into the fabric, such a solution takes advantage of the good flexibility of carbon fiber and its ability to weave into various shapes. The implanted carbon fiber heaters are washable, waterproof, powered by a DC power supply, and do not make noise. However, the carbon fiber heaters cannot be exposed to air because the resistance value of the exposed carbon fiber heaters increases significantly with the passage of time. In addition, the carbon fiber heating body itself will generate static electricity when rubbing, which will have an impact on the wearer of the fabric. Usually, the temperature of the carbon fiber heaters is usually controlled by means of power control, i.e., by changing the voltage on the carbon fiber heaters, which often brings about a loss of power and then affects the heating and holding time of the carbon fiber heaters.

### SUMMARY

In view of known solutions in the art, it is desired to provide a flexible heat generator that is washable and can be used continuously with power supply or reused with disposable batteries.

Another object of the disclosure is to provide a flexible heat generator that does not contain chemical catalysts that are harmful to humans.

Another object of the disclosure is to provide a flexible heat generator that can be exposed to air without affecting its heating effect and control difficulty.

Another object of the disclosure is to provide a flexible heat generator that can self-control its temperature.

The herein mentioned objects are achieved with a flexible heat generator. The flexible heat generator 1 comprises: a first flexible substrate layer, a first conductive line arranged on the first flexible substrate layer, wherein the first conductive line comprises a first positive line and a first negative line, a first heat generating line arranged on the first flexible substrate layer and covering a portion of the first conductive line, a second flexible substrate layer arranged on the first flexible substrate layer and covering the first conductive line and the first heat generating line, wherein the second flexible substrate layer is bonded to the first flexible substrate layer by means of a hot-pressing process, and a first connector arranged between the first flexible substrate layer and the second flexible substrate layer and electrically connected to the first conductive line, wherein the first positive line and the first negative line are not directly connected to each other, and wherein the first positive line is electrically connected to the first negative line by means of the first heat generating line.

According to an embodiment, the flexible heat generator comprises: a second conductive line arranged on an opposite side of the first flexible substrate layer relative to the first conductive line, wherein the second conductive line comprises a second positive line and a second negative line, a second heat generating line arranged on the first flexible substrate layer and covering a portion of the second conductive line, a third flexible substrate layer arranged on the first flexible substrate layer and covering the second conductive line and the second heat generating line, wherein the third flexible substrate layer is bonded to the first flexible substrate layer by means of a hot-pressing process, and a second connector arranged between the first flexible substrate layer and the third flexible substrate layer and electrically connected to the second conductive line, wherein the second positive line and the second negative line are not directly connected to each other, and wherein the second positive line is electrically connected to the second negative line by means of the second heat generating line.

According to an embodiment, the first positive line and the first negative line are arranged in a comb shape each comprising a main portion and a plurality of branch portions, the main portion of the first positive line and the main portion of the first negative line are parallel to each other, the branch portions of the first positive line and the branch portions of the first negative line are arranged alternately with each other, and the first heat generating line comprises a plurality of linear heat generating lines parallel to each other, each linear heat generating line covers at least one of the branch portions of the first positive line and one of the branch portions of the first negative line.

According to an embodiment, the first connector comprises a first positive terminal and a first negative terminal, the main portion of the first positive line is connected to the positive terminal of the first connector, and the main portion of the first negative line is connected to the negative terminal of the first connector.

According to an embodiment, the second positive line and the second negative line each comprises a straight section, the straight sections of the second positive line and the second negative line are parallel to each other, the second heat generating line comprises a plurality of linear heat generating lines parallel to each other, each linear heat generating line covers a portion of the straight section of the second positive line and a portion of the straight section of the second negative line.

According to an embodiment, the second connector comprises a second positive terminal connected to the second positive line and a second negative terminal connected to the second negative line.

According to an embodiment, the first flexible substrate layer, the second flexible substrate layer and the third flexible substrate layer are made from TPU.

According to an embodiment, the first conductive line and the second conductive line both comprise a silver foil formed by silver printing.

According to an embodiment, the first heat generating line and the second heat generating line comprise a PTC carbon foil formed by carbon paste printing.

The herein mentioned objects are achieved also with a method of manufacturing a flexible heat generator. The method comprising the steps of: printing the first conductive line on the first flexible substrate layer, heating the first flexible substrate layer at a first temperature for a first time period to cure the first conductive line on the first flexible substrate layer, printing a first heat generating line on the first flexible substrate layer with the first conductive line cured on it, heating the first flexible substrate layer at a second temperature for a second time period to cure the first heat generating line on the first flexible substrate layer, connecting a first connector to the first conductive line such that a portion of the first connector is external to the flexible heat generator, covering the first flexible substrate layer with a second flexible substrate layer, and hot-pressing the second flexible substrate layer at a third temperature for a third time period to bond the second flexible substrate layer to the first flexible substrate layer.

According to an embodiment, the first temperature is between 60° C.-150° C., the first time period is between 10 min-20 min, the second temperature is between 60° C.-150° C., the second time period is between 10 min-20 min, the third temperature is between 120° C.-200° C., and/or the third time period is between 30 sec-120 sec.

The herein mentioned objects are achieved also with a flexible heat generator (1) which comprises: a first flexible substrate layer, a first positive line arranged on the first flexible substrate layer, a first heat generating line arranged on the first positive line and covering a portion of the first positive line, a first negative line arranged on the first flexible substrate layer and covering a portion of the first heat generating line, a second flexible substrate layer covering the first positive line, the first heat generating line and the first negative line, wherein the second flexible substrate layer is bonded to the first flexible substrate layer by means of a hot-pressing process, and a first connector arranged between the first flexible substrate layer and the second flexible substrate layer and electrically connected to the first positive line and the first negative line, wherein the first positive line and the first negative line are not directly connected to each other, and wherein the first positive line is electrically connected to the first negative line by means of the first heat generating line. According to the present disclosure, the property that the resistance of PTC carbon foil changes with temperature is utilized, making the PTC carbon foil a thermistor, so that the change in resistance is tested by means of a circuit, and then fed back to a controller, thus making the flexible heat generator able to adjust the temperature precisely.

The flexible heat generator of the present disclosure can be connected to a DC power source or an AC power source for use. In the case of connection to AC power, the flexible heat generator of the present disclosure can be used continuously without replacement. In the case of connection to a DC power source, the flexible heat generator of the present disclosure can be used for a longer period of time by replacing the battery or recharging it. The flexible heat generator of the present disclosure is made with the aid of a hot-pressing process, and the flexible heat generator is made without chemical catalysts that are harmful to humans. The flexible heat generator of the present disclosure is encapsulated with an insulating material such as TPU material, so that it can be exposed to air without affecting its heat generation effect and control difficulty. The flexible heat generator of the present disclosure comprises a PTC carbon foil capable of self-control of temperature, and thus does not require complex structure to control its temperature.

### BRIEF DESCRIPTION OF THE DRAWINGS

For a better understanding of the present disclosure reference is made to the following detailed description when read in conjunction with the accompanying drawings, wherein like reference characters refer to like parts throughout the several views, and in which:

FIG. 1 schematically illustrates an explosion view of a flexible heat generator according to an embodiment of the present disclosure;

FIG. 2 illustrates a flowchart of a method of manufacturing the flexible heat generator of FIG. 1;

FIG. 3 schematically illustrates an explosion view of a flexible heat generator according to another embodiment of the present disclosure;

FIG. 4 schematically illustrates an explosion view of a flexible heat generator according to another embodiment of the present disclosure; and

FIG. 5 illustrates a flowchart of a method of manufacturing the flexible heat generator of FIG. 4.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that embodiments may be embodied in different forms. As such, the embodiments should not be construed to limit the scope of the disclosure. As referenced above, in some embodiments, well-known processes, well-known device structures, and well-known technologies may not be described in detail.

The terminology used herein is for the purpose of describing particular embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

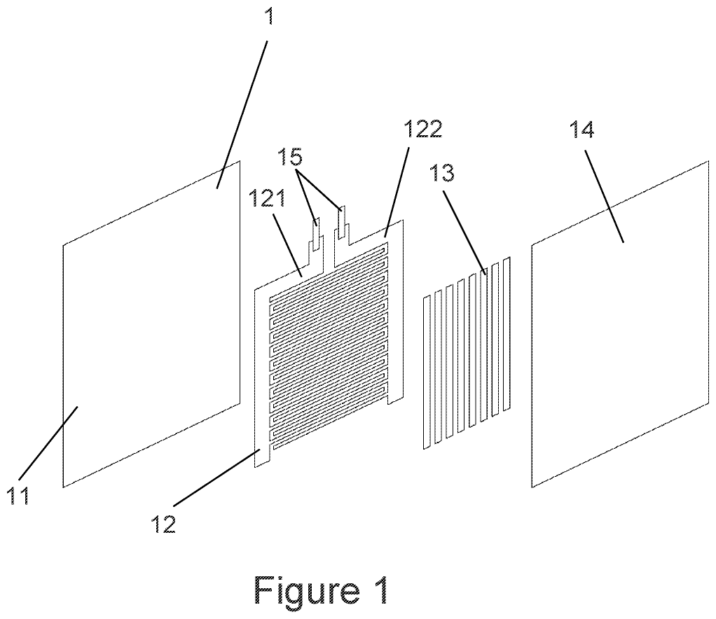

FIG. 1 schematically illustrates an explosion view of a flexible heat generator according to an embodiment of the present disclosure. The flexible heat generator 1 comprises: a first flexible substrate layer 11, a first conductive line 12, a first heat generating line 13, a second flexible substrate layer 14, and a first connector 15. The first conductive line 12 is arranged on the first flexible substrate layer 11. The first heat generating line 13 is arranged on the first flexible substrate layer 11 and covers a portion of the first conductive line 12. The second flexible substrate layer 14 is arranged on the first flexible substrate layer 11 and covers the first conductive line 12 and the first heat generating line 13. The first connector 15 is arranged between the first flexible substrate layer 11 and the second flexible substrate layer 14 and electrically connected to the first conductive line 12.

The first conductive line 12 comprises a first positive line 121 and a first negative line 122. The first positive line 121 and the first negative line 122 are not directly connected to each other.

In this embodiment, the first positive line 121 and the first negative line 122 are arranged in a comb shape each comprising a main portion and a plurality of branch portions. The main portion of the first positive line 121 and the main portion of the first negative line 122 are parallel to each other. The branch portions of the first positive line 121 and the branch portions of the first negative line 122 are arranged alternately with each other. The first heat generating line 13 comprises a plurality of linear heat generating lines parallel to each other. Each linear heat generating line covers at least one of the branch portions of the first positive line 121 and one of the branch portions of the first negative line 122.

It is to be understood that in other embodiments, the first positive line 121 and the first negative line 122 can be arranged in other shapes, such as an S-shape. In that case, the first heat generating line 13 comprises a plurality of linear heat generating lines arranged in parallel, each linear heat generating line covering at least a portion of the first positive line 121 and a portion of the first negative line 122.

The second flexible substrate layer 14 is bonded to the first flexible substrate layer 11 by means of a hot-pressing process.

In this embodiment, the first connector 15 is connected to a DC power source. The first connector 15 comprises a positive terminal which is connected to DC positive and a negative terminal which is connected to DC negative. The main portion of the first positive line 121 is connected to the positive terminal of the first connector 15. The main portion of the first negative line 122 is connected to the negative terminal of the first connector 15. By the connection to the DC power source such as a battery, the flexible heat generator 1 can be used for a longer period of time by replacing the battery or recharging it.

It is to be understood that in other embodiments, the first connector 15 can be connected to an AC power source. In that case, the first connector 15 can comprise a fire terminal which is connected to AC fire and a zero terminal which is connected to AC zero. By the connection to the AC power source, the flexible heat generator 1 can be used continuously without replacement.

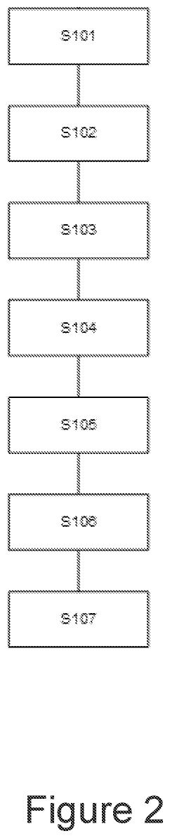

FIG. 2 schematically illustrates a flowchart of a method of manufacturing the flexible heat generator of FIG. 1. The method comprises the steps of:
printing S101 the first conductive line 12 on the first flexible substrate layer 11,
heating S102 the first flexible substrate layer 11 at a first temperature for a first time period to cure the first conductive line 12 on the first flexible substrate layer 11,
printing S103 a first heat generating line 13 on the first flexible substrate layer 11 with the first conductive line 12 cured on it,
heating S104 the first flexible substrate layer 11 at a second temperature for a second time period to cure the first heat generating line 13 on the first flexible substrate layer 11,
connecting S105 a first connector 15 to the first conductive line 12 such that a portion of the first connector 15 is external to the flexible heat generator 1,
covering S106 the first flexible substrate layer 11 with a second flexible substrate layer 14, and
hot-pressing S107 the second flexible substrate layer 14 at a third temperature for a third time period to bond the second flexible substrate layer 14 to the first flexible substrate layer 11.

In this embodiment, the first temperature is between 60° C.-150° C., preferably 120° C. The first time period is between 10 min-20 min, preferably 15 min. The second temperature is between 60° C.-150° C., preferably 120° C. The second time period is between 10 min-20 min, preferably 15 min. The third temperature is between 120° C.-200° C. The third time period is between 30 sec-120 sec.

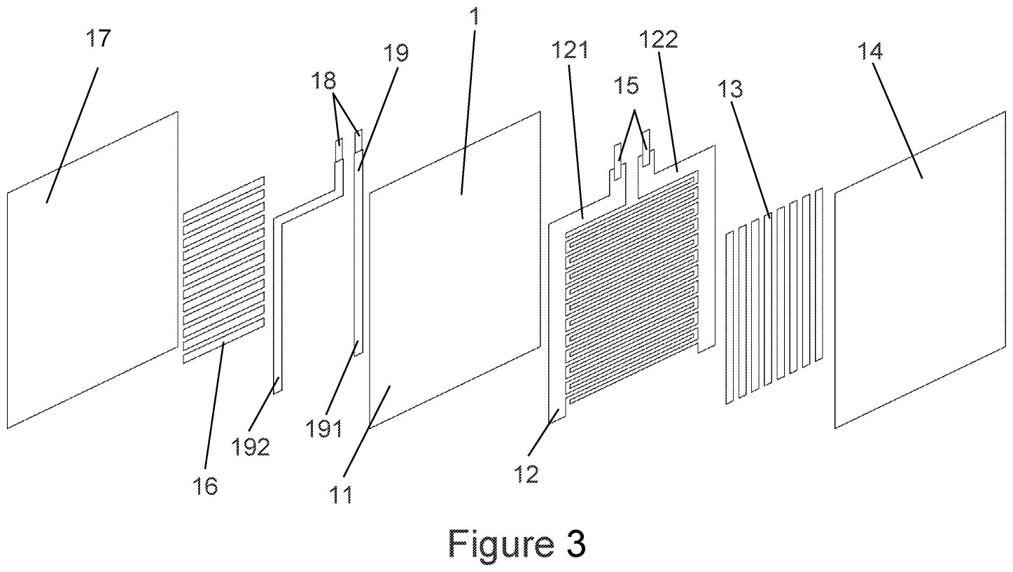

FIG. 3 schematically illustrates an explosion view of a flexible heat generator according to another embodiment of the present disclosure. In this embodiment, the flexible heat generator 1 further comprises a second conductive line 19, a second heat generating line 16, a third flexible substrate layer 17 and a second connector 18. The second conductive line 19 is arranged on an opposite side of the first flexible substrate layer 11 relative to the first conductive line 12. The second heat generating line 16 is arranged on the first flexible substrate layer 11 and covers a portion of the second conductive line 19. The third flexible substrate layer 17 is arranged on the first flexible substrate layer 11 and covers the second heat generating line 16. The third flexible substrate layer 17 is bonded to the first flexible substrate layer 11 by means of a hot-pressing process. The second connector 18 is arranged between the first flexible substrate layer 11 and the third flexible substrate layer 17 and is electrically connected to the second conductive line 19.

The second conductive line 19 comprises a second positive line 191 and a second negative line 192. The second positive line 191 and the second negative line 192 are not directly connected to each other.

In this embodiment, the second positive line 191 and the second negative line 192 each comprises a straight section. The straight sections of the second positive line 191 and the second negative line 192 are parallel to each other. The second heat generating line 16 comprises a plurality of linear heat generating lines parallel to each other. Each linear heat generating line covers a portion of the straight section of the second positive line 191 and a portion of the straight section of the second negative line 192. That is to say, the second positive line 191 is electrically connected to the second negative line 192 by means of the second heat generating line 16.

In this embodiment, the second connector 18 comprises a second positive terminal connected to the second positive line 191 and a second negative terminal connected to the second negative line 192.

In this embodiment, the first flexible substrate layer 11, the second flexible substrate layer 14 and the third flexible substrate layer 17 are made from TPU. The first conductive line 12 and the second conductive line 19 both comprise a silver foil formed by silver printing. The silver foil has very good electrical conductivity and therefore its heat generation is very low, making it suitable for being arranged in areas where heat generation is not required. The positive line 121 is electrically connected to the negative line 122 by means of the first heat generating line 13. In other words, the first heat generating line 13 does not need to be directly connected to the first connector 15, which allows the first heat generating line 13 to be arranged away from the first connector 15, greatly increasing the flexibility of the flexible heat generator 1. The flexible heat generator 1 according to the present disclosure can be configured to have the first heat generating line 13 arranged only at the location where the heat is most needed, without having to arrange the first heat generating line 13 from the first connector 15 all the way to that location.

The first heat generating line 13 and the second heat generating line 16 comprise a PTC carbon foil formed by carbon paste printing with PTC inks. Positive Temperature Coefficient (PTC) carbon foil changes resistance as it gets heated and cooled. As the temperature of the carbon foil increases, the electrical resistance also increases. In simpler terms, current flows through the carbon foil when it's cold, and the flow is restricted when the temperature gets hotter. The resistivity of the carbon foil increases exponentially with temperature for all temperatures up to the design temperature. Hence, it has strong PTC properties for all temperatures and heats up rapidly. Above this temperature the carbon foil is an electrical isolator and ceases to produce heat. This makes the carbon foil self-limiting. The carbon foil is thin and flexible and can be formed to any shape and size.

The flexible heat generator 1 utilizes the property that the resistance of the PTC carbon foil changes with temperature. The PTC carbon foil is used as a thermistor, so that the change in resistance may be identified by means of a circuit, and then fed back to a controller, making the flexible heat generator 1 able to adjust the temperature precisely.

The method of manufacturing the flexible heat generator of FIG. 3 is similar to the method of manufacturing the flexible heat generator of FIG. 1 but further comprises the steps of:
printing the second conductive line 19 on the opposite side of the first flexible substrate layer 11 relative to the first conductive line 12,
heating the first flexible substrate layer 11 at the first temperature for the first time period to cure the second conductive line 19 on the first flexible substrate layer 11,
printing a second heat generating line 16 on the first flexible substrate layer 11 with the second conductive line 19 cured on it,
heating the first flexible substrate layer 11 at the second temperature for the second time period to cure the second heat generating line 16 on the first flexible substrate layer 11,
connecting the second connector 18 to the second conductive line 19 such that a portion of the second connector 18 is external to the flexible heat generator 1,
covering the first flexible substrate layer 11 with the third flexible substrate layer 17,
hot-pressing the third flexible substrate layer 17 at the third temperature for the third time period to bond the third flexible substrate layer 17 to the first flexible substrate layer 11.

In this embodiment, the first temperature is between 60° C.-150° C., preferably 120° C. The first time period is between 10 min-20 min, preferably 15 min. The second temperature is between 60° C.-150° C., preferably 120° C. The second time period is between 10 min-20 min, preferably 15 min. The third temperature is between 120° C.-200° C. The third time period is between 30 sec-120 sec.

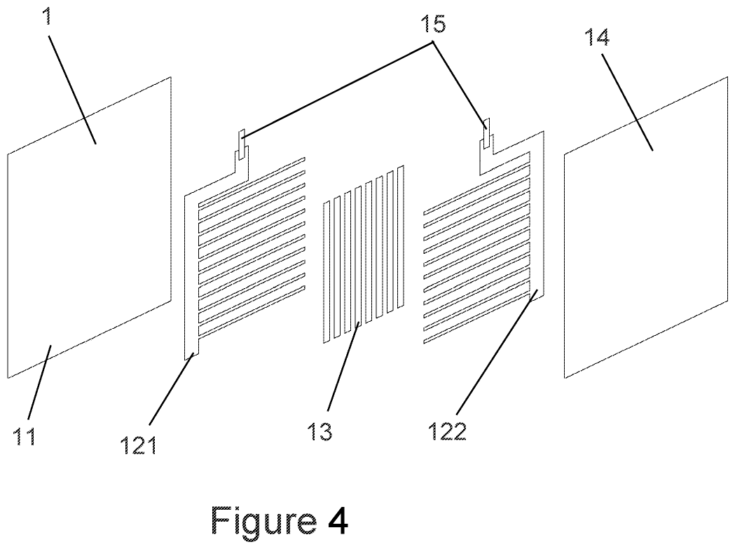

FIG. 4 schematically illustrates an explosion view of a flexible heat generator according to another embodiment of the present disclosure. The difference between the embodiment in FIG. 3 and the embodiment in FIG. 1 is that the first heat generating line 13 only covers the first positive line 121 in FIG. 3 instead of covering both the first positive line 121 and the first negative line 122. In FIG. 3, the flexible heat generator 1 comprises a first flexible substrate layer 11, a first positive line 121, a first heat generating line 13, a first negative line 122, a second flexible substrate layer 14, and a first connector 15. The first positive line 121 is arranged on the first flexible substrate layer 11. The first heat generating line 13 is arranged on the first positive line 121 and covers a portion of the first positive line 121. The first negative line 122 is arranged on the first flexible substrate layer 11 and covers a portion of the first heat generating line 13. The second flexible substrate layer 14 covers the first positive line 121, the first heat generating line 13 and the first negative line 122. The second flexible substrate layer 14 is bonded to the first flexible substrate layer 11 by means of a hot-pressing process. The first connector 15 is arranged between the first flexible substrate layer 11 and the second flexible substrate layer 14 and is electrically connected to the first positive line 121 and the first negative line 122. The first positive line 121 and the first negative line 122 are not directly connected to each other. The first positive line 121 is electrically connected to the first negative line 122 by means of the first heat generating line 13.

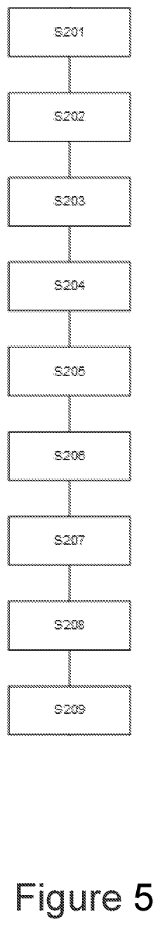

FIG. 5 schematically illustrates a flowchart of a method of manufacturing the flexible heat generator of FIG. 4. The method comprises the steps of:
printing S201 the first positive line 121 on the first flexible substrate layer 11,
heating S202 the first flexible substrate layer 11 at the first temperature for the first time period to cure the first positive line 121 on the first flexible substrate layer 11,
printing S203 the first heat generating line 13 on the first flexible substrate layer 11 with the first positive line 121 cured on it,
heating S204 the first flexible substrate layer 11 at the second temperature for the second time period to cure the first heat generating line 13 on the first flexible substrate layer 11,
printing S205 the first negative line 122 on the first flexible substrate layer 11 with the first positive line 121 and first heat generating line 13 cured on it,
heating S206 the first flexible substrate layer 11 at the first temperature for the first time period to cure the first negative line 122 on the first flexible substrate layer 11,
connecting S207 the first connector 15 to the first positive line 121 and the first negative line 122 such that a portion of the first connector 15 is external to the flexible heat generator 1,
covering S208 the first flexible substrate layer 11 with the second flexible substrate layer 14, and
hot-pressing S209 the second flexible substrate layer 14 at the third temperature for the third time period to bond the second flexible substrate layer 14 to the first flexible substrate layer 11.

In this embodiment, the first temperature is between 60° C.-150° C., preferably 120° C. The first time period is between 10 min-20 min, preferably 15 min. The second temperature is between 60° C.-150° C., preferably 120° C. The second time period is between 10 min-20 min, preferably 15 min. The third temperature is between 120° C.-200° C. The third time period is between 30 sec-120 sec.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1: A flexible heat generator (1), comprising:
a first flexible substrate layer (11),
a first conductive line (12) arranged on the first flexible substrate layer (11),
wherein the first conductive line (12) comprises a first positive line (121) and a first negative line (122),
a first heat generating line (13) arranged on the first flexible substrate layer (11) and covering a portion of the first conductive line (12),
a second flexible substrate layer (14) arranged on the first flexible substrate layer (11) and covering the first conductive line (12) and the first heat generating line (13), wherein the second flexible substrate layer (14) is bonded to the first flexible substrate layer (11) by means of a hot-pressing process, and
a first connector (15) arranged between the first flexible substrate layer (11) and the second flexible substrate layer (14) and electrically connected to the first conductive line (12),
wherein the first positive line (121) and the first negative line (122) are not directly connected to each other, and
wherein the first positive line (121) is electrically connected to the first negative line (122) by means of the first heat generating line (13).

2: The flexible heat generator (1) according to claim 1, wherein the flexible heat generator (1) comprises:
a second conductive line (19) arranged on an opposite side of the first flexible substrate layer (11) relative to the first conductive line (12), wherein the second conductive line (19) comprises a second positive line (191) and a second negative line (192),
a second heat generating line (16) arranged on the first flexible substrate layer (11) and covering a portion of the second conductive line (19),
a third flexible substrate layer (17) arranged on the first flexible substrate layer (11) and covering the second conductive line (19) and the second heat generating line (16), wherein the third flexible substrate layer (17) is bonded to the first flexible substrate layer (11) by means of a hot-pressing process, and a second connector (18) arranged between the first flexible substrate layer (11) and the third flexible substrate layer (17) and electrically connected to the second conductive line (19),
wherein the second positive line (191) and the second negative line (192) are not directly connected to each other, and
wherein the second positive line (191) is electrically connected to the second negative line (192) by means of the second heat generating line (16).

3: The flexible heat generator (1) according to claim 2, wherein:
the first positive line (121) and the first negative line (122) are arranged in a comb shape each comprising a main portion and a plurality of branch portions,
the main portion of the first positive line (121) and the main portion of the first negative line (122) are parallel to each other,
the branch portions of the first positive line (121) and the branch portions of the first negative line (122) are arranged alternately with each other, and the first heat generating line (13) comprises a plurality of linear heat generating lines parallel to each other,
each linear heat generating line covers at least one of the branch portions of the first positive line (121) and one of the branch portions of the first negative line (122).

4: The flexible heat generator (1) according to claim 3, wherein:
the first connector (15) comprises a first positive terminal and a first negative terminal,
the main portion of the first positive line (121) is connected to the positive terminal of the first connector (15), and
the main portion of the first negative line (122) is connected to the negative terminal of the first connector (15).

5: The flexible heat generator (1) according to claim 2, wherein:
the second positive line (191) and the second negative line (192) each comprises a straight section, the straight sections of the second positive line (191) and the second negative line (192) are parallel to each other,
the second heat generating line (16) comprises a plurality of linear heat generating lines parallel to each other,
each linear heat generating line covers a portion of the straight section of the second positive line (191) and a portion of the straight section of the second negative line (192).

6: The flexible heat generator (1) according to claim 5, wherein:
the second connector (18) comprises a second positive terminal connected to the second positive line (191) and a second negative terminal connected to the second negative line (192).

7: The flexible heat generator (1) according to claim 2, wherein:
the first flexible substrate layer (11), the second flexible substrate layer (14) and the third flexible substrate layer (17) are made from TPU.

8: The flexible heat generator (1) according to claim 2, wherein:
the first conductive line (12) and the second conductive line (19) both comprise a silver foil formed by silver printing.

9: The flexible heat generator (1) according to claim 2, wherein:
the first heat generating line (13) and the second heat generating line (16) comprise a PTC carbon foil formed by carbon paste printing.

10: A method of manufacturing the flexible heat generator (1) according to claim 1, wherein the method comprising the steps of:
printing (S101) the first conductive line (12) on the first flexible substrate layer (11),
heating (S102) the first flexible substrate layer (11) at a first temperature for a first time period to cure the first conductive line (12) on the first flexible substrate layer (11),
printing (S103) a first heat generating line (13) on the first flexible substrate layer (11) with the first conductive line (12) cured on it,
heating (S104) the first flexible substrate layer (11) at a second temperature for a second time period to cure the first heat generating line (13) on the first flexible substrate layer (11),
connecting (S105) a first connector (15) to the first conductive line (12) such that a portion of the first connector (15) is external to the flexible heat generator (1),
covering (S106) the first flexible substrate layer (11) with a second flexible substrate layer (14), and
hot-pressing (S107) the second flexible substrate layer (14) at a third temperature for a third time period to bond the second flexible substrate layer (14) to the first flexible substrate layer (11).

11: The method according to claim 10, wherein:
the first temperature is between 60° C.-150° C.,
the first time period is between 10 min-20 min,
the second temperature is between 60° C.-150° C.,
the second time period is between 10 min-20 min,
the third temperature is between 120° C.-200° C., and/or
the third time period is between 30 sec-120 sec.

12: A flexible heat generator (1), comprising:
a first flexible substrate layer (11),
a first positive line (121) arranged on the first flexible substrate layer (11),
a first heat generating line (13) arranged on the first positive line (121) and covering a portion of the first positive line (121),
a first negative line (122) arranged on the first flexible substrate layer (11) and covering a portion of the first heat generating line (13),
a second flexible substrate layer (14) covering the first positive line (121), the first heat generating line (13) and the first negative line (122), wherein the second flexible substrate layer (14) is bonded to the first flexible substrate layer (11) by means of a hot-pressing process, and
a first connector (15) arranged between the first flexible substrate layer (11) and the second flexible substrate layer (14) and electrically connected to the first positive line (121) and the first negative line (122),
wherein the first positive line (121) and the first negative line (122) are not directly connected to each other, and
wherein the first positive line (121) is electrically connected to the first negative line (122) by means of the first heat generating line (13).
